(19) United States
(12) Patent Application Publication
(10) Pub. No.: US 2015/0166787 A1
(43) Pub. Date: Jun. 18, 2015

(54) NON-HALOGENATED FLAME RETARDANT POLYCARBONATE COMPOUNDS

(71) Applicant: PolyOne Corporation, Avon Lake, OH (US)

(72) Inventors: Roger W. Avakian, Solon, OH (US); Ling Hu, Westlake, OH (US)

(73) Assignee: PolyOne Corporation, Avon Lake, OH (US)

(21) Appl. No.: 14/416,415

(22) PCT Filed: Jul. 24, 2013
(86) PCT No.: PCT/US2013/051887

§ 371 Date: Jan. 22, 2015

Related U.S. Application Data
(60) Provisional application No. 61/675,545, filed on Jul. 25, 2012.

(51) Int. Cl. C08L 69/00

(52) U.S. Cl. CPC C08L 69/00

(57) ABSTRACT

A flame retardant polycarbonate compound is disclosed. The compound comprises a polycarbonate and non-halogenated bisphosphate ester as a flame retardant, along with talc, and acrylic modified polytetrafluoroethylene, and optionally, polyphosphazene and/or a potassium salt of perfluorobutane sulfonic acid. The compound can achieve a UL 94 rating of V-0 at two different thicknesses of less than 1 mm.

### CLAIM OF PRIORITY

This application claims priority from U.S. Provisional Patent Application Ser. No. 61/675,545 bearing Attorney Docket Number 12012011 and filed on Jul. 25, 2012, which is incorporated by reference.

### FIELD OF THE INVENTION

This invention concerns thermoplastic polymer compounds which are flame retardant using non-halogenated ingredients.

### BACKGROUND OF THE INVENTION

Thermoplastic compounds, unlike wood, metal, or glass, do not rot, rust, or shatter. For that reason, the world in the past seventy years has seen a revolution in material science arising from the combination of a thermoplastic resin and one or more functional additives to provide specific properties to the resin.

Unlike wood but like metal and glass, at a given temperature, a thermoplastic resin can melt. Its processing versatility benefits from its capacity to mix with the functional additives while in a molten state.

But in use, the exposure of a fully formed thermoplastic article to excessive heat or flame can be quite detrimental to property and person.

Flame retardants, drip suppressants, mineral fillers, and char formers are functional additives which can be used to help the thermoplastic compound to retard the effects of heat or flame from melting or even burning. Flame retardant thermoplastic compounds are particular needed when the plastic article is used in any confined space where persons might be present during any condition, planned or emergency, which might expose the plastic article to such excessive heat or flame.

Non-halogenated flame retardants have recently become popular because they minimize the release of halogenated chemicals if the plastic article would begin to degrade, melt, or burn.

### SUMMARY OF THE INVENTION

What the art needs is a non-halogenated thermoplastic compound capable of passing the Underwriters' Laboratories Test No. 94 (UL 94 test) by achieving a V-0 rating.

Even with the variety of functional additives commercially available, it is not a predictable pathway for a person having ordinary skill in the art to find a particular combination of ingredients which, together, can achieve a V-0 rating in a UL 94 test.

The present invention has found a particular combination of known ingredients which, together, achieve a V-0 rating in a UL 94 test, at thicknesses ranging from about 0.4 mm to 0.7 mm, less than the thickness of one American dime ($0.10) coin, a task very difficult and unpredictable to achieve.

Starting with polycarbonate as the thermoplastic resin chosen for its physical properties, a non-halogenated flame retardant is combined with other functional ingredients to achieve that coveted V-0 rating.

One aspect of the present invention is a flame retardant polycarbonate compound, comprising polycarbonate, bisphosphate ester, talc, and acrylic modified polytetrafluoroethylene, wherein the bisphosphate ester is present in the compound at a weight percent from 7 to about 15, and wherein the compound injected molded and tested at a thickness of 0.75 mm has a UL 94 rating of V-0.

Features of the invention will be explored below.

### EMBODIMENTS OF THE INVENTION

### Polycarbonate

Any polycarbonate is a candidate for use in the compound, whether obtained from petrochemical or bio-derived sources, whether virginal or recycled.

Polycarbonates can be branched or linear, a mixture of them being preferred in this invention. Polycarbonates can be aliphatic or aromatic, with the latter being preferred in this invention. Without undue experimentation, one of ordinary skill in the art can select a polycarbonate matrix based on considerations of cost, manufacturing technique, physical properties, chemical properties, etc.

Unpredictably, it has been found that a combination of branched and linear polycarbonate in compounds of the present invention performs better than only either branched polycarbonate or linear polycarbonate. Linear polycarbonate has a higher melt flow index than branched polycarbonate, and it is believed that the linear polycarbonate assists in the melt processing of the compound while the branched polycarbonate assists in the flame retardant performance.

Commercial manufacturers of polycarbonate are Sabic, Bayer, Teijin, Dow, and others.

Non-Halogenated Bisphosphate Esters

Bisphosphate esters as candidates for use in this invention contain no halogen atoms, which characterizes them as non-halogenated. One reason for using non-halogenated bisphosphate esters is that they are more economical as compared with other non-halogenated phosphorus-containing flame retardants.

Bisphosphate esters are commercially available and known as non-halogenated flame retardants. Specific examples of commercially available bisphosphate esters have the following structures and CAS Numbers:

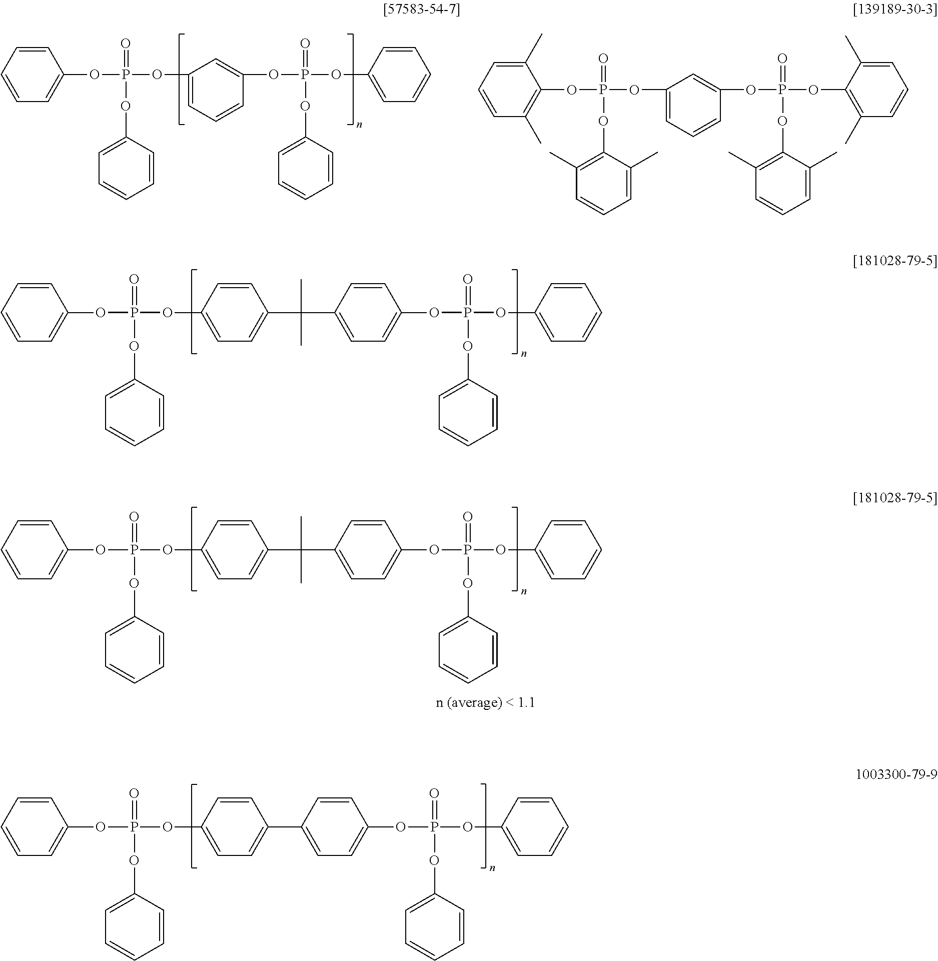

The foregoing examples of the non-halogenated bisphosphate esters can be used either alone or in combination. Of those examples listed above, all are pale yellow liquids except the second one, CAS No. 139189-30-3 and the last one, CAS No. 1003300-73-9, which are white granules. Granules are preferred for melt compounding because of easier solid material handling and processing. But liquid-based bisphosphate esters can also be used in the invention if suitable liquid material handling equipment such as dosing equipment is available for batch or continuous melt mixing with the polycarbonate and other solid ingredients.

Commercially available bisphosphate esters can be purchased from Adeka Palmarole of Saint Louis, France or Zhejiang Wangsheng Co., Ltd of Linhai City, Zhejiang Province, China. Presently preferred is WSFR-PX220 bisphosphate ester from Zhejiang Wangsheng Co. Ltd, because it is a white solid in granule form and has a melting point greater than 90° C.; a water content of less than 0.1 weight percent; and good compatibility with polycarbonate.

Talc

Talc is used in thermoplastic compounds as a mineral filler. In flame retardant thermoplastic compounds, talc can assist in flame retardance by being a barrier to oxygen and increasing viscosity of the molten polymer matrix during combustion.

Talc can have a particle size ranging about 0.5 μm to about 10 μm and preferably from about 0.5 μm to about 0.9 μm.

Talc is commercially available from a number of manufacturers. Presently preferred is Ultra Talc 609 from Specialty Minerals Company, which has a particle size of from about 0.5 μm to about 0.9 μm.

PTFE

Polytetrafluoroethylene is known to be useful as a drip suppressant because it tends fibrillate and elongate during injection molding. Fibrils shrink upon exposure to heat from a flame and hence retard dripping of the matrix in which the fibrils reside.

PTFE can have a particle size ranging from about 5 μm to about 25 μm with the possibility of aggregration and agglomeration.

PTFE is commercially available from a number of manufacturers, but the best known is Teflon™ brand from DuPont which invented the polymer.

PTFE also can be supplied with modification, such as an acrylic-modified PTFE which is advertised to improve dispersibility of the PTFE into the thermoplastic compound. Metablen A-3800 acrylic-modified PTFE is commercially available from Mitsubishi Rayon America, Inc. and is presently preferred because of that improved dispersibility.

Though PTFE is fluorinated, its presence in the compound is not regarded by those having skill in the art of flame retardant compounds as compromising the non-halogenated characteristics of the flame retardant itself because the amount of PTFE present is very minor. Therefore, the use of a fluorinated drip suppressant in the amounts identified in this invention does not disqualify the compound from being considered a non-halogenated flame retarded thermoplastic compound according to the course of conduct in the thermoplastic compound industry.

Optional Polyphosphazene

In the event that a second type of non-halogenated flame retardant is desired, one can include polyphosphazene flame retardants in the thermoplastic compounds of the invention because polyphosphazene flame retardants have excellent hydrolytic stability, better than bisphosphate esters.

U.S. Pat. No. 6,518,336 (Yabuhara et al.) and U.S. Pat. No. 6,743,841 (Shimizu et al.), both of which are incorporated by reference herein, disclose non-halogenated polyphosphazenes which are candidates for use in this invention. Briefly, U.S. Pat. No. 6,518,336 discloses four types of polyphosphazenes.

(1) Cyclic polyphosphazenes represented by the Formula (1)

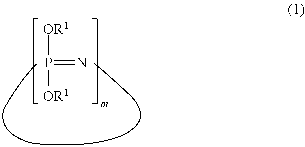

wherein m is an integer of 3 to 25, two R¹ groups are the same or different and each represents a phenyl group substituted with at least one group selected from the class consisting of alkyl groups having 1 to 6 carbon atoms and an allyl group or an unsubstituted phenyl group.

(2) Straight-chain polyphosphazenes represented by the Formula (2)

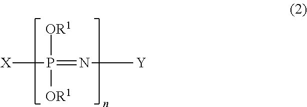

wherein n is an integer of 3 to 1000, R¹ is as defined above, X represents a group —N═P(OR¹)₃ or a group —N═P(O)OR¹, and Y represents a group —P(OR¹)₄ or a group —P(O)(OR¹)₂.

(3) Crosslinked polyphosphazenes wherein at least one of the foregoing phosphazenes (1) and (2) is crosslinked with at least one crosslinking group selected from the group consisting of o-phenylene, m-phenylene, p-phenylene, biphenylene, and a group represented by

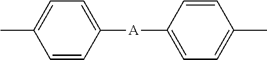

wherein A is a group —SO₂—, a group —S—, a group —O— or a group —C(CH₃)₂—, each of said crosslinking groups being interposed between the two oxygen atoms left after the elimination of group R¹ from the phosphazene (1) or (2), and the number of the R¹ groups in the crosslinked phosphazene being 50 to 99.9% based on the total number of R¹ groups in the phosphazene prior to the crosslinking.

(4) At least one polyphosphazene selected from the group consisting of cyclic polyphosphazenes represented by formula (3)

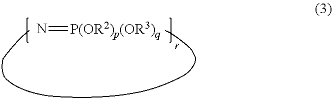

wherein R² is a cyano-substituted phenyl group; R³ is an alkyl group having 1 to 18 carbon atoms or an aryl group having 6 to 10 carbon atoms; these groups may be substituted with at least one group selected from alkyl groups having 1 to 10 carbon atoms, allyl group and aryl groups; when two or more R³ groups exist, the R³ groups may be the same or different; p and q are numbers which fulfill the requirements that p>0, q. 0, and p+q=2; and r is an integer of 3 to 25, and a straight-chain polyphosphazene represented by the formula (4)

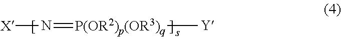

wherein R², R³, p and q are as defined above; s is an integer of 3 to 1000; X′ is a group —P(OR)41 a group —P(OR²)₃(OR³), a group —P(OR²)₂(OR³)₂, a group —P(OR²)(OR³)₃, a group —P(OR³)₄, a group —P(O)(OR²)₂, a group —P(O)(OR²)(OR³), or a group —P(O)(OR³)₂; and Y′ is a group —N═P(OR²)₃, a group —N═P(OR²)₂(OR³), a group —N═P(OR²)(OR³)₂, a group —N═P(OR³)₃, a group —N═P(O)OR² or a group —N═P(O)OR³.

The foregoing examples of the non-halogenated polyphosphazenes can be used either alone or in combination.

Specific examples of the cyclic polyphosphazene (1) and the straight-chain polyphosphazene (2) include a mixture of phosphazenes in which phenoxy groups and/or alkoxy groups are introduced as substituents and which are obtainable from a mixture of cyclic and straight-chain chlorophosphazenes, e.g., hexachlorocyclotriphosphazene, octachlorocyclotetra-phosphazene and the like, prepared by reacting ammonium chloride and phosphorus pentachloride at about 120 to about 130° C.; and hexaphenoxycyclotriphosphazene, octaphenoxycyclotetraphosphazene, decaphenoxycyclo-pentaphosphazene, hexaalkoxycyclotriphosphazene, octaalkoxycyclotetraphosphazene, decaalkoxycyclopenta-phosphazene and like cyclic phosphazenes obtained by isolating, from the above mixture of chlorophosphazenes, hexachlorocyclotriphosphazene, octachlorocyclotetraphosphazene, decachlorocyclopenta-phosphazene or like single substances, followed by substitution with a phenoxy group and/or an alkoxy group.

Specific examples of the straight-chain polyphosphazenes (2) include those obtained by heating (at 220 to 250° C.) hexachlorocyclotriphosphazene for ring-opening polymerization to give dichlorophosphazene, followed by substitution with a phenoxy group and/or an alkoxy group.

Specific examples of the crosslinked polyphosphazenes (3) are phenoxyphosphazene having 4,4′-sulfonyldiphenylene(bisphenol-S residue) group-crosslinked structure, phenoxyphosphazene having 2,2-(4,4′-diphenylene)isopropylidene group-crosslinked structure, phenoxyphosphazene having 4,4′-oxydiphenylene group-crosslinked structure, phenoxyphoshazene having 4,4′-thiodiphenylene group-crosslinked structure, phenoxyphosphazene having 4,4′-diphenylene group-crosslinked structure, etc.

Specific examples of the polyphosphazenes (4) are monocyanophenoxypentaphenoxycyclotriphosphazene, dicyanophenoxytetraphenoxycyclotriphosphazene, tricyanophenoxytriphenoxycyclotriphosphazene, tetracyanophenoxydiphenoxycyclotriphosphazene, pentacyanophenoxymonophenoxycyclotriphosphazene and like cyclotriphosphazene compounds; monocyanophenoxyhepta-phenoxycyclotetraphosphazene, dicyanophenoxyhexaphenoxycyclotetraphosphazene, tricyanophenoxypentaphenoxy-cyclotetraphosphazene, tetracyanophenoxytetraphenoxy-cyclotetraphosphazene, pentacyanophenoxytriphenoxycyclotetraphosphazene, hexacyanophenoxydiphenoxy-cyclotetraphosphazene, heptacyanophenoxymonophenoxy-cyclotetraphosphazene and like cyclotetraphosphazenes; cyclopentaphosphazenes having both cyanophenoxy and phenoxy groups as substituents; and like cyclic phosphazenes; and straight-chain phosphazenes having both cyanophenoxy and phenoxy groups as substituents.

Among these polymers, preferred are a mixture of polyphenoxyphosphazenes which have phenoxy groups as substituents and which are obtainable from a mixture of cyclic and straight-chain chlorophosphazenes, phenoxyphosphazene having 4,4′-sulfonyldiphenylene-crosslinked structure; phenoxyphosphazene having 2,2-(4,4′-diphenylene)-isopropylidene group-crosslinked structure; and polyphosphazenes having both cyanophenoxy and phenoxy groups as substituents.

Commercially available polyphosphazenes can be purchased from Otsuka Chemical Co., Ltd. of Osaka, Japan. Presently preferred as an optional second flame retardant is SPB 100 polyphosphazene from Otsuka.

Optional Char Former

Flame retardant thermoplastic compounds can benefit from the presence of char formers, chemicals which assist in the retention of the original shape of the plastic article by the formation of char from the compound.

One known char former is perfluorobutane sulfonic acid, potassium salt, which is sold as neat powder or as pellets of a masterbatch, with the latter being preferred for processing efficiency. The char former is considered optional for use in the compound of this invention because, as the Examples demonstrated, the compound does not need this particular functional additive to achieve a UL 94 V-0 rating.

Perfluorobutane sulfonic acid, potassium salt is commercially available as Bayowet C4 MB masterbatch (6% salt (CAS No. 029420-49-3) in polycarbonate pellets) or Bayowet C4 powder (CAS No. 029420-49-3) from Lanxess Deutschland GmbH.

Optional Other Additives

The compound of the present invention can include conventional plastics additives in an amount that is sufficient to obtain a desired processing or performance property for the compound. The amount should not be wasteful of the additive nor detrimental to the processing or performance of the compound. Those skilled in the art of thermoplastics compounding, without undue experimentation but with reference to such treatises as Plastics Additives Database (2004) from Plastics Design Library (www.elsevier.com), can select from many different types of additives for inclusion into the compounds of the present invention.

Non-limiting examples of optional additives include adhesion promoters; biocides (antibacterials, fungicides, and mildewcides), anti-fogging agents; anti-static agents; bonding, blowing and foaming agents; dispersants; fillers and extenders; smoke suppressants; impact modifiers; initiators; lubricants; micas; pigments, colorants and dyes; plasticizers, such as core/shell impact modifiers; processing aids; release agents; silanes, titanates and zirconates; slip and anti-blocking agents; stabilizers; stearates; ultraviolet light absorbers; viscosity regulators; waxes; catalyst deactivators, and combinations of them.

Ingredients

Table 1 shows the acceptable, desirable, and preferred amounts of each of the ingredients discussed above, recognizing that the optional ingredients need not be present at all. The compound can comprise the ingredients, consist essentially of the ingredients, or consist of the ingredients. All amounts are expressed in weight percent of the total compound.

All ingredients other than the polycarbonate matrix can be added individually to the matrix or any two or more of them can be added together.

TABLE 1
Range of Ingredients
(Weight Percent)

| | Acceptable | Desirable | Preferable |
|---|---|---|---|
| Polycarbonate Matrix | 80-90 | 82-88 | 85-87 |
| Bisphosphate Ester | 7-15 | 7-12 | 7-10 |
| Talc | 2-9 | 3-8 | 4-6 |
| Acrylic Modified | 0.1-0.8 | 0.3-0.7 | 0.4-0.6 |
| Polytetrafluoroethylene | | | |
| Optional | 0-7 | 0-5 | 0-3.5 |
| Polyphosphazene | | | |
| Optional Potassium salt | 0-0.2 | 0-0.1 | 0-0.01 |
| of perfluorobutane | | | |
| sulfonic acid | | | |
| Optional Other | 0-5 | 0-3 | 0-2 |
| Additives | | | |

Processing

The preparation of compounds of the present invention is uncomplicated. The compound of the present can be made in batch or continuous operations.

Mixing in a continuous process typically occurs in a single or twin screw extruder that is elevated to a temperature that is sufficient to melt the polymer matrix with addition of other ingredients either at the head of the extruder or downstream in the extruder. Extruder speeds can range from about 50 to about 500 revolutions per minute (rpm), and preferably from about 350 to about 450 rpm. Typically, the output from the extruder is pelletized for later extrusion or molding into polymeric articles.

Mixing in a batch process typically occurs in a Banbury mixer that is capable of operating at a temperature that is sufficient to melt the polymer matrix to permit addition of the solid ingredient additives. The mixing speeds range from 60 to 1000 rpm. Also, the output from the mixer is chopped into smaller sizes for later extrusion or molding into polymeric articles.

Subsequent extrusion or molding techniques are well known to those skilled in the art of thermoplastics polymer engineering. Without undue experimentation but with such references as “Extrusion, The Definitive Processing Guide and Handbook”; “Handbook of Molded Part Shrinkage and Warpage”; “Specialized Molding Techniques”; “Rotational Molding Technology”; and “Handbook of Mold, Tool and Die Repair Welding”, all published by Plastics Design Library (www.elsevier.com), one can make articles of any conceivable shape and appearance using compounds of the present invention.

### Usefulness of the Invention

Thermoplastic compounds can be shaped by extrusion, molding, calendering, thermoforming, or other means of shaping into any plastic article usable in an interior or confined space where fire can cause personal injury or property damage. The compounds resist melting and dripping.

Literally any plastic article useful in a human-occupied space such as a building, a vehicle, or a tunnel can benefit from the flame retardancy of this polycarbonate compound.

Because the physical properties of polycarbonate compounds are known, which are believed to not be deleteriously affected by the addition of the bisphosphate ester, the talc, and the acrylic modified PTFE, and optionally the polyphosphazene and/or the sulfonic acid salt char former, any plastic article which is currently made from a polycarbonate compound can now be made from the non-halogenated flame retardant compound of this invention.

Polycarbonate itself has superior flame retardant properties when compared to other polymer resins, such as polyolefins. The inherent flame retardant properties of polycarbonate assisted in achieving the UL 94 V-0 rating at very thin dimensions after the addition of the bisphosphate ester, the talc, the acrylic modified PTFE, and optionally, the polyphosphazene and/or the sulfonic acid salt char former.

By achieving a UL 94 V-0 rating at a thickness as thin as 0.4 mm, it is known that a plastic article having any larger thickness will also achieve a UL 94 V-0 rating.

Thermoplastic articles are sold into the following markets: appliance, building and construction, consumer, electrical and electronic, healthcare, industrial, packaging, textiles, transportation, and wire and cable. Compounds of this invention can be used in any of those markets regardless of thickness above 0.4 mm, 40% of the thickness of a United States dime ($0.10) coin.

As stated repeatedly, Underwriters' Laboratories Test No. UL 94 serves as the litmus test for flame retardant thermoplastic compounds. As seen in Table 2, the V-0 rating is distinguished from V-1 and V-2 ratings, which are less acceptable if one is seeking the best flame retardance rating. For certain uses, V-1 is acceptable.

TABLE 2

| Criteria Conditions | V-0 | V-1 | V-2 |
|---|---|---|---|
| Afterflame time for each | ≦10 s | ≦30 s | ≦30 s |
| individual specimen t₁ or t₂ | | | |
| Total afterflame time for any | ≦50 s | ≦250 s | ≦250 s |
| condition set (t₁ plus t₂ for the | | | |
| 5 specimens) | | | |
| Afterflame plus afterglow | ≦30 s | ≦60 s | ≦60 s |
| time for each individual | | | |
| specimen after the second | | | |
| flame application (t₂ + t₃) | | | |
| Afterflame or afterglow of | No | No | No |
| any specimen up to the | | | |
| holding clamp | | | |
| Cotton indicator ignited by | No | No | Yes |
| flaming particles or drops | | | |

Examples provide data for evaluation of the unpredictability of this invention.

### EXAMPLES

Table 3 shows the ingredients chosen for Examples 1-4 and Comparative Examples A-E.

TABLE 3

| Ingredients | Details and Sources |
|---|---|
| Branched Polycarbonate | Branched Polycarbonate pellets, |
| | Makrolon 1239, from Bayer |
| Linear Polycarbonate | Linear Polycarbonate pellets, |
| | Makrolon 2658, from Bayer |
| Pigment | 9019-BK-99 Carbon Black MB |
| | pellets, from PolyOne Shenzhen |
| | Color & Additive (China) |
| Bisphosphate Ester | WSFR-PX220-Bisphosphate |
| | ester Flame retardant from |
| | Wangsheng Co., Ltd (China) |
| Talc | Talc: Ultra Talc 609 powder |
| | from Specialty Minerals |
| Acrylic Modified PTFE | Metablen A-3800 from |
| | Mitsubishi Rayon America |
| Stabilizer | Irganox 1010 Stabilizer Package |
| | powder from BASF |
| Antioxidant | Ultranox 627A, antioxidant |
| | powder from Chemtura |
| Mold Release Wax | Licowax E powder, ester of |
| | montanic acids, from Clariant |

Table 4 shows the mixing conditions in a Leistritz ZSE-18HP (L/D=41) twin screw extruder with all raw materials in pellet form being pre-mixed and then fed at throat at Barrel 1 and with all raw materials in powder form being pre-mixed and also fed at the throat at Barrel 1. The temperature in all zones was set at 270° C., with the values reported as measured.

The extrudate was pelletized, while in a water bath, for later injection or compression molding.

TABLE 4
Extruder Conditions

| | 1 | 2 | 3 | 4 | A | B |
|---|---|---|---|---|---|---|
| Zone 1 (° C.) | 256 | 245 | 247 | 255 | 253 | 255 |
| Zone 2 (° C.) | 270 | 269 | 271 | 269 | 272 | 269 |
| Zone 3 (° C.) | 270 | 269 | 270 | 270 | 274 | 269 |
| Zone 4 (° C.) | 269 | 269 | 273 | 272 | 275 | 270 |
| Zone 5 (° C.) | 271 | 270 | 270 | 267 | 272 | 270 |
| Zone 6 (° C.) | 270 | 269 | 272 | 271 | 277 | 271 |
| Zone 7 (° C.) | 278 | 275 | 274 | 280 | 280 | 275 |
| Zone 8-Die (° C.) | 272 | 250 | 256 | 268 | 260 | 260 |
| RPM/Side | 400/ | 400/ | 400/ | 400/ | 400/ | 400/ |
| screw RPM | 209 | 209 | 209 | 209 | 209 | 209 |
| % Torque | 47 | 42 | 46 | 35 | 44 | 50 |
| Die Press (psi) | 675 | 699 | 780 | 590 | 728 | 780 |
| Melt Temp (° C.) | 276 | 274 | 275 | 276 | 275 | 276 |
| Feeder Rate #_1_ | 87.20 | 87.20 | 87.20 | 87.20 | 89.20 | 88.20 |
| S/M (lbs./hr.) | | | | | | |
| (Pellets) | | | | | | |
| Feeder Rate #_2_ | 12.80 | 12.80 | 12.80 | 12.80 | 10.80 | 11.80 |
| S/M (lbs./hr.) | | | | | | |
| (Powder) | | | | | | |
| Total Feed Rate | 15 | 15 | 15 | 15 | 15 | 15 |
| (lbs./hr.) | | | | | | |
| Vacuum (Mbar) | 185 | 185 | 185 | 185 | 185 | 185 |

| | C | D | E |
|---|---|---|---|
| Zone 1 (° C.) | 250 | 250 | 256 |
| Zone 2 (° C.) | 275 | 267 | 271 |
| Zone 3 (° C.) | 274 | 68 | 269 |
| Zone 4 (° C.) | 275 | 270 | 270 |
| Zone 5 (° C.) | 274 | 273 | 270 |
| Zone 6 (° C.) | 274 | 273 | 270 |
| Zone 7 (° C.) | 280 | 280 | 272 |
| Zone 8-Die (° C.) | 269 | 268 | 278 |
| RPM/Side screw | 400/ | 400/ | 400/ |
| RPM | 209 | 209 | 209 |
| % Torque | 33 | 34 | 33 |
| Die Press (psi) | 610 | 675 | 621 |
| Melt Temp (° C.) | 277 | 276 | 275 |
| Feeder Rate #_1_ | 92.20 | 87.70 | 92.70 |
| S/M (lbs./hr.) | | | |
| (Pellets) | | | |
| Feeder Rate #_2_ | 7.80 | 12.30 | 7.30 |
| S/M (lbs./hr.) | | | |
| (Powder) | | | |
| Total Feed Rate | 15 | 15 | 15 |
| (lbs./hr) | | | |
| Vacuum (Mbar) | 185 | 185 | 185 |

The extrudate was pelletized for later molding.

Before molding, the pellets were dried for more than 4 hours at 120° C. to reduce moisture content to less than 0.02%.

Using a DeMag molding machine, Table 5 shows the settings used to mold test bars of each Example and Comparative Example having a thickness of 0.75 mm.

TABLE 5
Injection Molding Conditions

| Temperatures: | |
|---|---|
| Nozzle (° C.) | 271 |
| Zone 2 (° C.) | 271 |
| Zone 3 (° C.) | 265 |
| Zone 4 (° C.) | 265 |
| Mold (° C.) | 77 |
| Oil Temp (° C.) | 32 |
| Speeds: | |
| Screw RPM | 150 |
| % Shot - Inj Vel (in/sec) | 2~2.5 |
| Pressures: | |
| Injection Pressure (psi) | 1834 |
| Hold Pressure (psi) | 800 |
| Back Pressure (psi) | 50 |
| Timers: | |
| Injection Hold (sec) | 6 |
| Cure/Cool Time (sec) | 10 |
| Fill Time (sec) | 0.55 |
| Cycle Time (sec) | 28.1 |
| Operation Settings: | |
| Shot Size (in) | 0.85 |
| Cushion (in) | 0.18 |
| Cut-off Position (in) | 0.2 |
| Decompression (in) | 1.05 |

Samples of all Examples and Comparative Examples were also subjected to compression molding into films of 0.4˜0.5 mm thickness. About 30 to 40 g of the material was placed between two Teflon™ coated trays, inserted into a PHI 40000 ton manual hydraulic press (model: P2150) preheated at 221° C. (430° F.), then started slowly increasing pressure to 4.13-6.2 MPa (600-900 psi) over 2 minutes. After that, remove the plates from the press and cooled for 3-5 minutes to take out film with a thickness of about 0.4˜0.5 mm. From those films, an Arbor fitted with a flexural die cut a flame bar sample shape out of the film for UL 94 testing.

Samples of all Examples and Comparative Examples were also subjected to extrusion into films of about 0.4 mm thickness. The materials were extruded in a single-screw extruder (model: C.W. Brabender 2503 No. 1914) with L/D of 3:1 and diameter of 0.5″, and passed through a die with 4″ die width and 1.4 mm die slit to form a tape. The extruder barrel temperature was 260-270° C. for zone 1, zone 2, zone 3 and die. The extruded tapes were pulled off by a C.W. Brabender Univex Take-Off Roll (Model SFR-100-B. No. 468). The thickness of films ranged from 0.43 to 0.35 mm. The thickness was adjusted by extruder rpm and the speed of the take-off roll. The extruder rpm was about 60-70 rpm. The speed ranging from 0 to 100 of the DC motor of the take-off roll was set about 12 to 30. From the films, an Arbor fitted with a flexural die cut a flame bar sample shape out of the film for UL 94 testing.

Table 6 shows the flame performance tested for each Example and Comparative Example.

TABLE 6
Physical Properties

| Ingredients | 1 | 2 | 3 | 4 | Comp. A | Comp. B |
|---|---|---|---|---|---|---|
| | Formulation in Wt. % | | | | | |
| Branched | 66.2 | 43.1 | 86.2 | | 68.2 | 67.2 |
| Polycarbonate | | | | | | |
| Linear Polycarbonate | 20 | 43.1 | | 86.2 | 20 | 20 |
| Pigment | 1 | 1 | 1 | 1 | 1 | 1 |
| Bisphosphate Ester | 7 | 7 | 7 | 7 | 5 | 6 |
| Talc | 5 | 5 | 5 | 5 | 5 | 5 |
| PTFE | 0.5 | 0.5 | 0.5 | 0.5 | 0.5 | 0.5 |
| Stabilizer | 0.1 | 0.1 | 0.1 | 0.1 | 0.1 | 0.1 |
| Antioxidant | 0.1 | 0.1 | 0.1 | 0.1 | 0.1 | 0.1 |
| Mold Release Wax | 0.1 | 0.1 | 0.1 | 0.1 | 0.1 | 0.1 |
| Total | 100 | 100 | 100 | 100 | 100 | 100 |
| Thickness of Sample | UL Flammability Rating (UL 94 Test harmonized with ISO 9772/9773) | | | | | |
| 0.75 mm, injection | V-0 | V-0 | V-0 | V-0 | V-2 | V-1 |
| molded flexural bar* | | | | | | |
| 0.4-0.5 mm bar | V-2 | V-2 | V-2 | V-2 | V-2 | V-2 |
| compression molded | | | | | | |
| 0.4-0.5 mm extruded | V-0 | V-1 | V-1 | V-1 | V-not | V-1 |
| film | | | | | | |

| Ingredients | Comp. C | Comp. D | Comp. E |
|---|---|---|---|
| Branched | 71.2 | 66.7 | 71.7 |
| Polycarbonate | | | |
| Linear Polycarbonate | 20 | 20 | 20 |
| Pigment | 1 | 1 | 1 |
| Bisphosphate Ester | 7 | 7 | 7 |
| Talc | 0 | 5 | 0 |
| PTFE | 0.5 | 0 | 0 |
| Stabilizer | 0.1 | 0.1 | 0.1 |
| Antioxidant | 0.1 | 0.1 | 0.1 |
| Mold Release Was | 0.1 | 0.1 | 0.1 |
| Total | 100 | 100 | 100 |
| | UL Flammability Rating (UL Test | | |
| Thickness of Sample | harmonized with ISO 9772/9773) | | |
| 0.75 mm, injection | V-2 | V-2 | V-2 |
| molded flexural bar* | | | |
| 0.4-0.5 mm bar | V-2 | V-2 | V-2 |
| compression molded | | | |
| 0.4-0.5 mm, extruded | V-not | V-2 | V-2 |
| film | | | |

*Flame bar dimension: 5″ × ½″ (or 12.7 mm × 1.27 mm) with desired thickness

To the required ingredients of polycarbonate and bisphosphate ester flame retardant, two functional additives were evaluated, in of the three possible combinations because of the unpredictability of achieving a UL 94 V-0 test rating: polytetrafluoroethylene (PTFE) drip suppressant and talc mineral filler which serves as a viscosity enhancer.

Comparative Examples C-E demonstrate that, in order to achieve a UL 94 V-0 rating for either the 0.75 thickness (injection molded article such as Examples 1-4) or the 0.4-0.5 thickness (extruded film such as Example 1), both PTFE and talc are required in the compound.

Comparative Examples A and B demonstrated that even with both PTFE and talc present in the same amounts as in Examples 1-4, the UL 94 V-0 rating for either the 0.75 thickness (injection molded article) or the 0.4-0.5 thickness (extruded film) required at least 7 weight percent of bisphosphate ester. Five and six weight percent of bisphosphate ester were inadequate.

Of Examples 1-4, the use of branched or linear polycarbonate demonstrated that a combination of both branched and linear polycarbonate (Examples 1 and 2) had a better flame test result than either one or the other (Examples 3 and 4). And of Examples 1 and 2, the use of a superior amount of branched polycarbonate and an inferior amount of linear polycarbonate (Example 1) had better flame test performance than equal amounts (Example 2). Therefore, the formulation of Example 1 is preferred. Thus, the ratio of branched polycarbonate to linear polycarbonate can range from about 1.2:1 to about 3.6:1 and preferably from about 3.0:1 to about 3.4:1.

The invention is not limited to the above embodiments. The claims follow.

What is claimed is:

1. A flame retardant polycarbonate compound, comprising:
(a) polycarbonate,
(b) bisphosphate ester,
(c) talc, and
(d) acrylic modified polytetrafluoroethylene,
wherein the bisphosphate ester is present in the compound at a weight percent from 7 to about 15,
and wherein the compound injection molded and tested at a thickness of 0.75 mm has a UL 94 rating of V-0.

2. The compound of claim 1, further comprising the potassium salt of perfluorobutane sulfonic acid.

3. The compound of claim 1, further comprising polyphosphazene.

4. The compound of claim 1, wherein the polycarbonate is a mixture of a branched polycarbonate of virginal source, recycled source, or both, and a linear polycarbonate of virginal source, recycled source, or both.

5. The compound of claim 4, further comprising an additive selected from the group consisting of adhesion promoters; biocides; anti-fogging agents; anti-static agents; anti-oxidants; bonding, blowing and foaming agents; dispersants; fillers and extenders; smoke suppressants; impact modifiers; initiators; lubricants; micas; pigments, colorants and dyes; plasticizers; processing aids; release agents; silanes, titanates and zirconates; slip and anti-blocking agents; stabilizers; stearates; ultraviolet light absorbers; viscosity regulators; waxes; catalyst deactivators, and combinations of them.

6. The compound of claim 1, wherein the compound has ingredients in amounts expressed in weight percent:
Polycarbonate Matrix 80-90
Bisphosphate ester 7-15
Talc 2-9
Acrylic modified Polytetrafluoroethylene 0.1-0.8
Optional Polyphosphazene 0-7
Optional Potassium salt of perfluorobutane sulfonic acid 0-0.2
Optional Other Additives 0-5.

7. The compound of claim 1, wherein the compound has ingredients in amounts expressed in weight percent:
Polycarbonate Matrix 82-88
Bisphosphate ester 7-12
Talc 3-8
Acrylic Modified Polytetrafluoroethylene 0.3-0.7
Optional Polyphosphazene 0-5
Optional Potassium salt of perfluorobutane sulfonic acid 0-0.1
Optional Other Additives 0-3.

8. The compound of claim 1, wherein the compound has ingredients in amounts expressed in weight percent:
Polycarbonate Matrix 85-87
Bisphosphate ester 7-10
Talc 4-6
Acrylic modified Polytetrafluoroethylene 0.4-0.6
Optional Polyphosphazene 0-3.5
Optional Potassium salt of perfluorobutane sulfonic acid 0-0.01
Optional Other Additives 0-2.

9. A molded article made from the compound of claim 1.

10. An extruded article made from the compound of claim 1.

11. A calendered article made from the compound of claim 1.

12. A thermoformed article made from the compound of claim 1.

13. A method of using the compound of claim 1, comprising the step of shaping the compound into an article designed to resist combustion or molten dripping in the presence of flame.

14. The method of claim 13, wherein the polycarbonate of the compound is a mixture of a branched polycarbonate of virginal source, recycled source, or both and a linear polycarbonate of virginal source, recycled source, or both.

15. The method of claim 13, wherein the shaping comprises extruding, molding, calendering, or thermoforming.
